(19) United States
(12) Patent Application Publication
(10) Pub. No.: US 2013/0346891 A1
(43) Pub. Date: Dec. 26, 2013

(54) METHOD AND SYSTEM FOR VISUALIZATION OF MEDICAL IMAGING DATA

(71) Applicant: Julian Hayball, Oxfordshire (GB)

(72) Inventor: Julian Hayball, Oxfordshire (GB)

(21) Appl. No.: 13/912,491

(22) Filed: Jun. 7, 2013

(30) Foreign Application Priority Data
Jun. 8, 2012 (GB) 1210155.6

(51) Int. Cl. G06F 3/0481

(52) U.S. Cl. CPC G06F 3/0481
USPC 715/764

(57) ABSTRACT

In a method for visualization of medical imaging data representing a number of anatomical regions and/or a number of modalities, a set-up step and a usage step are executed at a computer workstation. In the set-up step, at least one set of visualization parameters is stored according to the preferences of a user for a particular modality and anatomical region for future use in a corresponding workflow.

### BACKGROUND OF THE INVENTION

1. Field of the Invention

The present invention concerns a computerized method and system for visualization of medical imaging data, such as at a viewing workstation at which a clinician reviews image data from a number of different patients and/or generated from a number of different imaging modalities.

2. Description of the Prior Art

Many different techniques for medical imaging have been developed. While these techniques provide valuable image data to assist with diagnosis and treatment, fully automatic analysis of the data is not yet possible, and so an experienced clinician is required to review image data from many patients to provide analysis and interpretation of the medical symptoms represented by the image data.

In a typical scenario the clinician may use a data visualization system to review all of a data set representing several organs. Corresponding data may be available in multiple modalities, representing the same organs. The clinician typically has access to multiple tools which are available to optimize visualization of the medical imaging data in each modality according to the clinician's adjustment of various parameters. The optimizations applied and the parameter values selected will depend on the imaging modality and the anatomical region, which is represented in the visualized data. Prior corresponding datasets may be available for comparison. Example tools used for such optimization may include window level, layout, zoom factor and the view port.

Each clinician will have a preferred combination of parameter values for visualization of a particular organ and imaging modality, and that clinician will generally use the preferred arrangement for viewing the particular organ in that modality. Of course, as circumstances dictate, the clinician may vary the visualization according to the requirements or that diagnosis by adjusting the available parameter values. It is not easy to define a correct combination of parameter values for any particular organ, as personal choice will influence the preferred arrangement for each clinician.

For instance, the clinician may start a review with a data subset representing the brain. The clinician will select a layout for visualization that shows the axial view of the current image data subset. The clinician may pan and zoom the visualization so that the viewed image of the head just fills the available viewed image size. The clinician may navigate the viewed image to a data slice representing the top of the head, and select a window level that provides the best contrast for the appearance of the brain tissue. The clinician typically views the brain image data subset by inspecting each axial slice consecutively from the top of the head to the base of the skull. Typically, the visualization parameter values selected when viewing the first slice of data for a particular organ will be found appropriate reviewing all slices of that organ. Once the examination of the brain image data subset is complete, the clinician may wish to examine the neck. A similar process will be repeated using different layouts, zoom factors, viewports and window levels according to the clinician's preference for images of this part of the anatomy.

Skilled clinicians who are capable of analyzing medical image data are highly skilled and their time is valuable both in terms of scarcity and cost. In adjusting viewing tools and parameters for visualization of each modality of each organ of the body, much of their time is taken up in adjusting visualization parameters so as to provide optimum viewing for each anatomical region. While this has conventionally been required, it is not regarded as an efficient use of a skilled clinician's time.

Conventionally, adjustable tools have been provided to allow the physician to individually adjust the visualization of each data subset to achieve optimal setting for each anatomical region and each imaging modality.

FIG. 1 illustrates workflow conventionally used by a clinician to you to review medical image data. Initially, in step 10, a dataset is loaded into a visualization system, which may be a suitably programmed general-purpose computer. Typically, a schematic representation of the whole dataset will be presented to the clinician, step 20. This may be a whole body representation of patient or part of the body corresponding to the range of data provided in the dataset. The clinician may then select a region of the body whose image data will be inspected, step 30, and may also select the imaging modality for visualization, step 35, if more than one is available. In the following example, the clinician will select the brain region as the first subset of the image data set to be visualized. The clinician then adjusts certain visualization parameters, step 40, according to his or her preference, applies those parameter values to the visualization system and uses them in inspecting the visualized data set, step 50. Further regions of interest may be visualized by selecting step 60, to repeat steps 30-50, or the process may end.

Medical image data is typically arranged into axial slices, that is to say, representing planes perpendicular to the head-to-toe direction of the patient. When the brain region is selected, and the clinician may adjust the available visualization parameters to obtain a suitably scaled and shaded image for review. For example, the slice corresponding to the widest part of the head may be selected and the zoom and window parameters adjusted such that the data of this slice fills the available viewing window. Shading, contrast and other visualization parameters may be adjusted according to the clinician's preference to assist the clinician with an evaluation of the visualized image.

The clinician may proceed to view other slices representing the head region from the crown where the image will fill only part of the available window, to lower slices which may fill the whole window. Once the clinician has finished examining the data representing the head region, he may move on to inspect data slices representing the neck region. The clinician may decide that the data slices, representing the neck may be viewed better with a different selection of viewing parameters. The clinician then adjusts the zoom level, contrast, shading and any other available parameters according to his preference for viewing the neck region. Once evaluation of the data representing the neck region is complete, the clinician may move on to inspect data slices representing other parts of the body. At each time that the clinician moves from evaluating one part of the body to another, he will typically adjust the visualization parameters to suit that part of body.

The medical image dataset may include data from multiple modalities. The clinician will typically readjust the visualization parameters for each modality and for each anatomical region.

### SUMMARY OF THE INVENTION

Overall, during an inspection of complete dataset, a significant portion of the clinician's time is occupied with adjusting and readjusting visualization parameters each time he or she moves from one data subset to another. The clinician's time is valuable both from a financial point of view and throughput quantity point of view. The present invention accordingly aims to reduce the amount of time clinician must spend adjusting visualization parameters, step 40, as he or she moves through a dataset representing different parts of a body.

The present invention aims to provide method for automating or at least assisting clinician in adjusting viewing tools and parameters as appropriate for viewing standard data subsets, typically representing particular organs in certain imaging modalities.

The present invention does not seek to impose a standard visualization setup or workflow sequence on a clinician, but rather provides an arrangement for storing their preferences and for recalling their preferences to save time in adjusting visualization parameter values when viewing corresponding data set in the future. On inspection of data representing a particular organ, the clinician may be offered a scope to vary the parameters of visualization from their stored values, as required.

### BRIEF DESCRIPTION OF THE DRAWINGS

FIG. 1 represents a conventional workflow as used by clinicians in evaluating medical image data representing multiple parts of a patient's body.

FIG. 2 represents a set-up phase of a workflow according to the present invention is may be used by clinicians in evaluating such medical image data.

FIG. 3 represents a memory map to schematically represent a feature of the present invention.

FIG. 4 represents a usage phase of a workflow according to the present invention is may be used by clinicians in evaluating such medical image data.

### DESCRIPTION OF THE PREFERRED EMBODIMENTS

The present invention provides a workflow-based configuration that allows each clinician to define a set of default and preferred visualization parameters corresponding to a generic anatomical region and imaging modality. Each clinician performs initial setup phase using an example dataset for each modality.

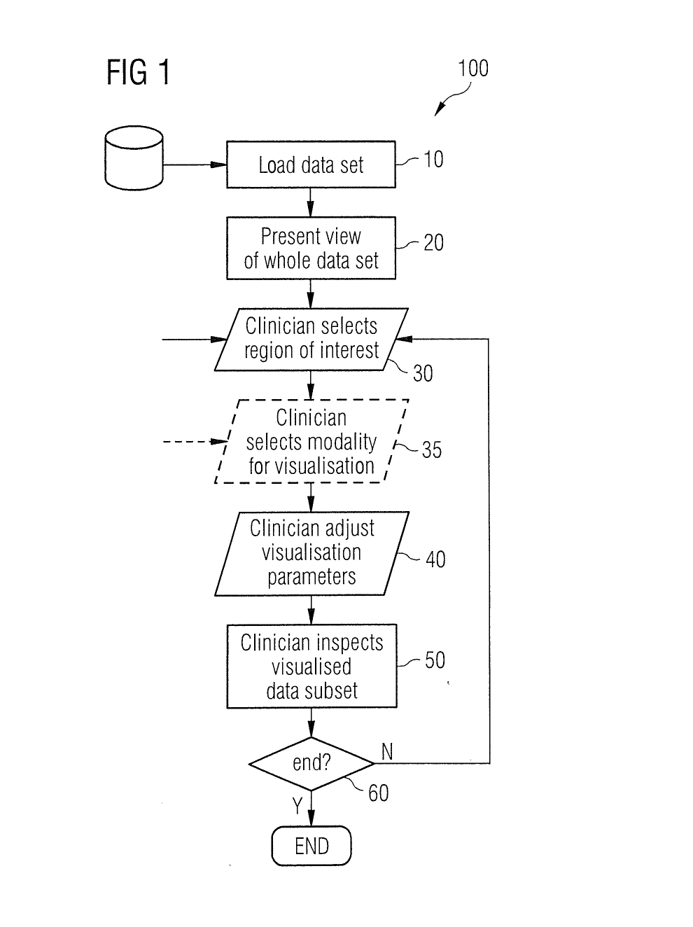

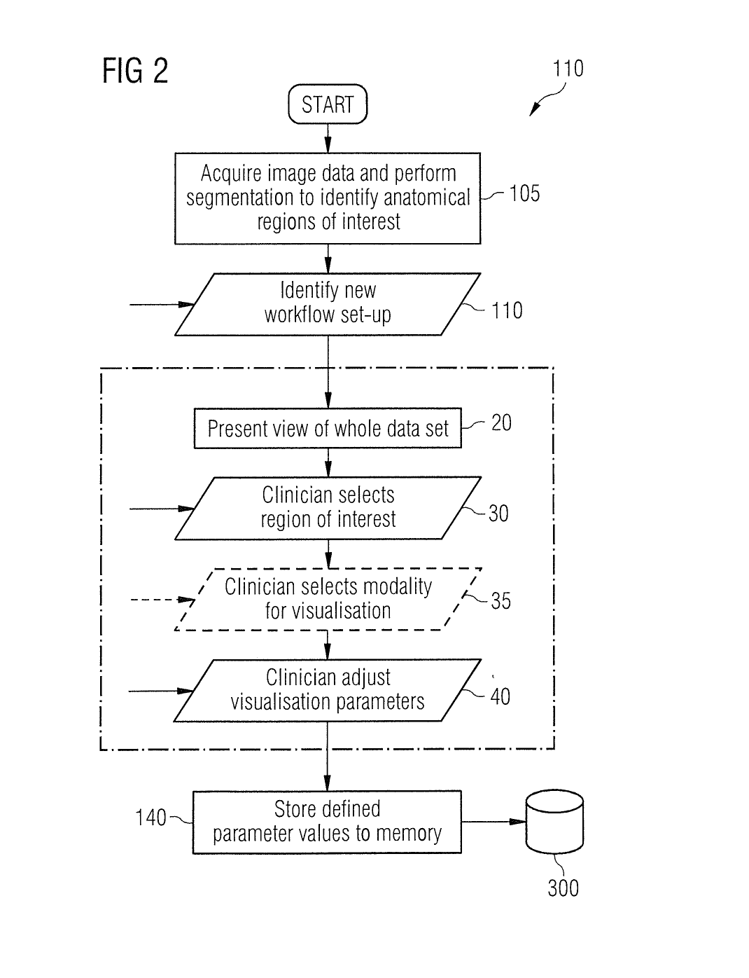

FIG. 2 represents a workflow improved according to the present invention. The same example dataset as referred to in FIG. 1 will be used in this example. Block 130 largely corresponds to steps 10 to 40 of the workflow of FIG. 1. Added step 140 provides storing the adjusted parameter values for each anatomical region and each modality in a memory 300.

The first part 120 of the workflow, shown in FIG. 2, is a set up phase. Initially, at step 105, a set of image data is acquired, and segmentation is performed to identify anatomical regions of interest. The clinician identifies a new workflow set-up to be defined, and gives it a name at step 110.

The clinician views medical image data and adjusts visualization parameter values according to his or her own preference for effective viewing of corresponding data slices, in block 130, and storing the parameter values in memory 300, step 140.

After each phase of adjusting visualization parameters, step 40, according to a feature of the present invention, the adjusted visualization parameters (i.e., parameter values) are stored in memory for later recall.

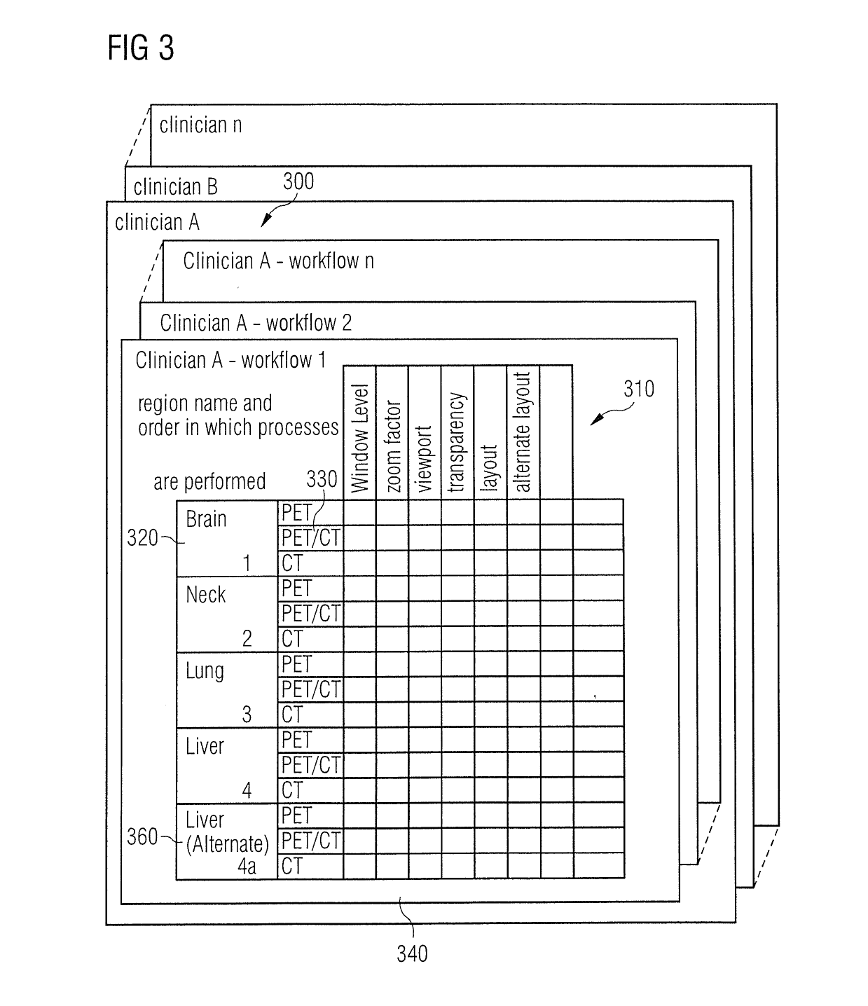

The set up phase of the workflow of FIG. 2 continues with the clinician adjusting further visualization parameters for each modality for each anatomical region, according to his or her preference, and storing those adjusted visualization parameters in the memory 300. The same process may be carried out repeatedly for other work flows and by other clinicians to produce corresponding memory maps 340, FIG. 3. In this way, each clinician 360 can store a complete set of visualization parameter values 310 according to his or her own personal preference.

The memory 300 is arranged to store values for each visualization parameter, for each clinician, for each anatomical region, and for each modality.

A schematic memory map 340 is shown in FIG. 3 illustrating the combination of visualization parameters that may be stored and recalled in memory 300 according to features of the present invention. For example, memory 300 may store adjusted values for each visualization parameter value 310, for the brain region 320 for CT images 330 for clinician A 360. The stored visualization parameters may include window level; zoom factor; viewport; transparency; layout; alternate layout, among others. For each clinician, e.g. clinician A, a series of workflows 340 is defined. For each workflow, multiple anatomical regions 320 may be studied. The clinician can define, for each workflow, the order in which the anatomical regions are studied may be defined. Each clinician may store their own series of workflows, as illustrated.

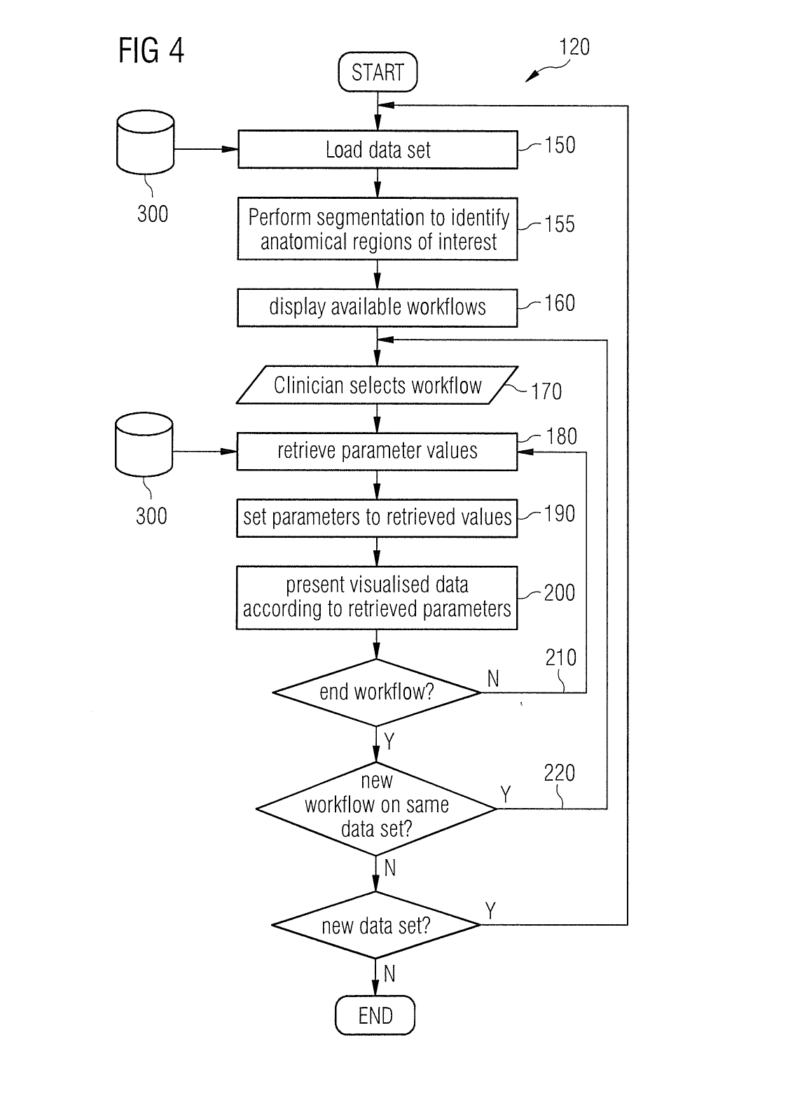

In a second phase 320 of the workflow, shown in FIG. 4, the usage phase, a clinician may view a medical image dataset in a similar manner to the set-up phase 120 of the workflow of FIG. 2, or the workflow of FIG. 1.

The clinician will then select a body region 320 for review and may select a particular data slice within that body region. If multiple image modalities 330 are present, the clinician may select a modality for viewing.

According to the present invention, adjusted visualization parameter values 310 stored by that clinician 360 are retrieved from the memory 300. The retrieved parameter values 310 correspond to the clinician 360, the workflow 340, the body region 320 and modality 330 of interest. The corresponding data slice is then displayed with the appropriate visualization parameter values 310.

The clinician then evaluates the data slice, displayed according to the corresponding pre-defined visualization parameter values retrieved from memory 300. The clinician may then navigate through consecutive slices of the same anatomical region 320 as required for the evaluation.

For each data slice viewed, the visualization system will use the corresponding visualization parameter values retrieved from the memory according to the clinician, the anatomical region and modality of interest. Preferably, the system allows the clinician to adjust visualization parameters 310 as required for effective viewing but the stored visualization parameters represent the clinician's earlier personal preference and should normally be sufficient to perform the required valuation.

The visualization parameters 310 corresponding to other modalities 330 and anatomical regions 320 are retrieved and used as the clinician changes between evaluations of image data representing other anatomical regions and modalities. Once the clinician has finished his or her evaluation, the system may return to default visualization parameters or may store the most recently used values of each parameter for re-use.

A different clinician 360 may then wish to use the visualization system. An initializing phase again will be required in which the clinician identifies himself or herself selects the required medical image dataset in step 150. The visualization system according to the present invention will then retrieve the appropriate values of visualization parameters from the memory 300 in step 180. These parameters will then be applied for display of the selected image data.

In instances where the clinician has not stored preferred values of visualization parameters, the memory may contain default values. Typically, such stored default parameter values provide acceptable visualization of the corresponding anatomical regions and modality. Preferably, the clinician is offered the chance to store his or her own preferred values in place of stored default values for the visualization parameters. Even where the clinician has stored his or her own preferred values, the system may allow variation of those parameters and may now allow the clinician to store adjusted values in memory in place of the previously stored values. Indeed, the memory may offer the clinician capacity to store multiple sets of preferred visualization parameter values for each anatomical region and each modality.

Typical visualization parameters which may be adjusted, stored and retrieved according to the present invention include the following:

Layout: the allocation of screen real estate to different views of data: for instance, a layout suitable for a PET acquisition may be a division of the screen into four views representing coronal, sagittal and axial sections with a maximum intensity projection view. One or more alternate layouts may also be specified.

Viewport: the spatial extent of the data displayed in the view.

Window level: the parameters that describe the contrast adjustment that is applied to a medical image for the purposes of optimizing visualization.

Zoom factor: the amount of magnifications applies to the image displayed in a view.

The above-described example refers generally to visualization of a dataset representing the whole body. The clinician may choose to store a different set of visualization parameter values for other workflows for example for viewing only the head region. For this reason, the setup phase represented in FIG. 2 preferably includes a workflow identification step 110. This may occur as the first step in the process where the clinician allocates a name to a workflow and may specify data requirements as preconditions for the workflow to be performed. These conditions may include the presence of PET data; the presence of CT data; the presence of PET/CT hybrid data and the presence of multi-time point data.

The clinician may then be presented with a list of anatomical regions 320, which may be in the form of an overview of a whole body dataset, or an example body dataset 10. These regions can be, for example a heart or brain, or for example the whole body. Each region must be capable of being detected within the image data using a simple segmentation algorithm. The clinician selects 30 the anatomical region he or she would view first in the examination routine workflow that the clinician is defining. The system then presents the physician with a configuration mechanism that allows them to select visualization parameters and to set chosen values for those parameters, for example window level parameter. This could be defined by the clinician as a fixed window level, or some algorithm may be selected to calculate an optimum window level from the data each time the workflow is performed. Clinicians may select a preferred visualization layout for the workflow 40. The layout may have particular views with further configuration options, for example a transparency parameter for maximum intensity projection representations, which may be made available for setting by the clinician.

An alternative anatomical region visualization workflow stage 370, FIG. 4, may be offered to the clinician, for storage of complete alternative sets of visualization parameters for an alternative workflow stage for that anatomical region. The modality and the associated anatomical region may be stored in the memory and the clinician may select the preferred layout or the alternative sets of parameter values as required during evaluation. More than one alternative set of parameter values 370 may be provided for each combination of anatomical region and modality, if required. The set of visualization parameters for each preferred alternative layout is stored in the memory as appropriate. A starting slice, in axial, coronal or sagittal plane may be defined for each workflow. This will typically be dependent on the anatomical region selected. For example, if the clinician selects the brain, they may define the starting slice at the top of the head. Then every time the clinician selects the brain region for review, the uppermost slice will be presented first. A zoom factor may be defined for each anatomical region or for an individual data slice. Alternatively, the clinician may elect to have the zoom factor calculated automatically using the size of the view in the viewed image data slice and the resultant segmentation. These steps are repeated for every anatomical region which is typically viewed in the workflow. The clinician must then save the stored visualization parameters, and the system will make these workflow parameters available for reuse in future visualizations.

When the clinician wishes to make a further visualization of medical imaging data, it is not necessary to readjust the visualization parameters. The system will offer the clinician the choice of workflows which have been defined as discussed above. The clinician will select the appropriate workflow appropriate to the data concerned.

The method steps relating to this usage phase are shown at 320 in FIG. 4. The system loads the appropriate image data set in step 150 and performs a basic segmentation 155 to identify key anatomical points that are required to perform an automated segmentation. In step 160, the system presents the clinician with available defined workflows that are allowable according to the preconditions configured for each workflow. For example, workflows used to visualize image data of the brain will only be offered where the loaded image data set includes a representation of the head. The clinician then selects, in step 170, one of the offered workflows. The system then retrieves 180 the appropriate parameter values in step 180 from memory and, in step 190, sets the defined parameters to the retrieved values as configured for the first anatomical region in the selected workflow. Such parameters typically include the layout window level, initial slice, and zoom factor. The clinician is then presented visualized data in step 200 according to the retrieved values of visualization parameters. The clinician may elect to view the data in an alternative layout. The system preferably offers the clinician a choice of switching visualization to an alternative layout where available, and a selection of appropriate values of visualization parameters which are being used.

The clinician may then perform a further review of the visualized data slice and may later move 210 to the next step in the workflow.

The next step may be visualization of a different anatomical region or visualization of the same anatomical region in a different modality. The system may allow more than one modality to be viewed at the same time and this option should be offered to the clinician where appropriate. The different modalities may be visualized in adjacent windows or may be combined into a single visualized image for example by applying some transparency to the data representing each modality.

The system loads the appropriate visualization parameter values from the memory and applies them to visualization of the appropriate data subset. The clinician may vary the visualization parameters as required for examination and may be offered the chance to save the varied visualization parameters in place of the stored parameter values, or as an alternative layout 370 or even as a new workflow definition. These steps are repeated until all configured anatomical regions within the selected workflow have been examined.

The clinician may then elect, in step 220, to perform a different workflow on the same image dataset and will be offered another selection 170 of appropriate workflows. Alternatively, the clinician may elect to load and new a new image dataset typically representing a different patient.

Once all required visualization of the loaded dataset has been performed, the clinician may choose, in step 230, to select another dataset for visualization, or the process may end.

Although multiple workflows are defined and employed by the clinician, the clinician is not constrained to work linearly through the predefined workflow. The system should offer options to skip or repeat certain parts of the defined workflow or perform certain steps in a different order. The defined parameter values may be adjusted as required but stored parameter values are intended to be the most likely to be suitable based on the clinician's experience and personal preferences as expressed during the setup stage 120.

The present invention accordingly provides a method and system for visualizing and examining medical image data by a clinician, in which less time is spent adjusting visualization parameters than is conventional.

The present invention accordingly allows clinicians to spend more of their available time in performing skilled evaluation of visualized image data and less time adjusting system parameters.

Although modifications and changes may be suggested by those skilled in the art, it is the intention of the inventor to embody within the patent warranted hereon all changes and modifications as reasonably and properly come within the scope of his contribution to the art.

I claim as my invention:

1. A computerized method for visualization of medical imaging data representing a plurality of anatomical regions and/or a plurality of modalities, comprising:
at a computerized workstation, presenting a set-up user interface followed by a usage user interface;
in said set-up user interface, allowing at least one set of visualization parameters to be stored in response to user-entered preferences of a user for a specific imaging modality and a specific anatomical region;
also in said set-up user interface, allowing the user to enter respective values for said visualization parameters, and storing the user-entered values of said visualization parameters; and
in said usage interface, retrieving the stored values of the visualization parameters and allowing the user to use the retrieved values of the visualization parameters to review a medical image by displaying said medical image according to the retrieved values of the visualization parameters.

2. A method as claimed in claim 1 comprising:
in said computerized workstation, segmenting medical imaging data representing said medical image in order to automatically identify respective body regions;
in said set-up interface, allowing the user to enter a set of values for said visualization parameters for at least one of the identified body regions; and
in said usage interface, performing said segmentation on said medical image data to identify said body regions, and allowing the user to select a workflow in which an anatomical region for visualization is identified, and retrieving the respective values of the visualization parameters for the selected anatomical region and displaying the selected anatomical region according to the retrieved values of the visualization parameters.

3. A method as claimed in claim 1 comprising storing multiple, different sets of values for different visualization parameters for each combination of anatomical region and modality.

4. A method as claimed in claim 1 comprising storing multiple, different sets of values of different visualization parameters for each of a plurality of different users.

5. A method as claimed in claim 1 comprising storing multiple, different sets of values of different visualization parameters for each different modality.

6. A method as claimed in claim 1 comprising storing multiple, different sets of values of different visualization parameters for each different anatomical region.

7. A method as claimed in claim 1 comprising, in said usage interface:
offering the user a selection of a stored set of workflows for reviewing the medical image, each workflow being linked to a set of values of said visualization parameters according to an identified anatomical region; and
allowing the user to select one of the stored workflows, and retrieving the set of values of visualization parameters associated with the selected workflow, and using the retrieved values for visualization of a subset of medical imaging data representing the medical image.

8. A computerized system for visualization of medical imaging data representing a plurality of anatomical regions and/or a plurality of modalities, comprising:
a computerized workstation comprising a processor and a display unit;
said processor being configured to present a set-up user interface at said display followed by a usage user interface;
in said set-up user interface, said processor being configured to allow at least one set of visualization parameters to be stored in response to user-entered preferences of a user for a specific imaging modality and a specific anatomical region;
also in said set-up user interface, said processor being configured to allow the user to enter respective values for said visualization parameters, and to store the user-entered values of said visualization parameters; and
in said usage interface, said processor being configured to retrieve the stored values of the visualization parameters and allow the user to use the retrieved values of the visualization parameters to review a medical image by displaying said medical image at said display unit according to the retrieved values of the visualization parameters.
